(19) United States
(12) Patent Application Publication
(10) Pub. No.: US 2009/0006164 A1
(43) Pub. Date: Jan. 1, 2009

(54) System and method for optimizing workforce engagement

(75) Inventors: John Joseph Kaiser, Dunlap, IL (US); Keith Edward Thach, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/819,777

(22) Filed: Jun. 29, 2007

(51) Int. Cl. G06F 9/46

(52) U.S. Cl. 705/8

(57) ABSTRACT

A method is provided for optimizing workplace engagement for a plurality of employees performing a plurality of tasks. The method may include receiving productivity data for each of the plurality of employees relative to each of the plurality of tasks and receiving forecasted demands for each of the plurality of tasks. The method may also include assigning one or more of the plurality of employees to one or more of the plurality of tasks. The employee task assignments may be based upon productivity data, availability data, and the forecasted demands. The method may further include determining that the forecasted demand for one of the plurality of tasks for the period of time falls below a predetermined threshold, and assigning an inexperienced employee to that one of the plurality of tasks.

### TECHNICAL FIELD

The present disclosure relates to workforce logistics management and, more particularly, to allocating workforce resources in a manner that optimizes workplace engagement by rotating employees through a number of various tasks when feasible.

### BACKGROUND

Many organizations around the world rely upon workforce capital in order to be successful. In particular, the success of these organizations may depend upon, among other things, effectively scheduling workforce resources, such that available resources are appropriately matched to the needs of the organization. The task of generating optimized schedules for the allocation of workforce resources has been known for years to be a complex one, and has spawned an entire industry of companies that provide products that assist with generation of such schedules. For instance, the use of such a product is described in U.S. Patent Publication No. 2004/0267591 to Hedlund et al. Specifically, the Hedlund et al. publication describes systems and methods for creating optimized work schedules for a set of human resources to insure optimum staff schedules based on forecasted demand, past schedules, employee skill sets, and employee preferences.

While conventional workforce management systems, such as, for example, the system described by Hedlund et al., may be capable of allocating workforce resources in a manner that meets forecasted demand as closely as possible, or, alternatively, meets a specific budget, such systems and tools fail to account for employee engagement. That is to say, known workforce management systems are incapable of facilitating optimization of employee engagement.

Since it has been determined that employee productivity may be connected to employee engagement, there is a need for providing systems and methods that are capable of allocating workforce resources in a manner that meets forecasted demands as closely as possible and optimizes employee engagement.

The present disclosure is directed to overcoming one or more of the shortcomings set forth above.

### SUMMARY OF THE INVENTION

In one aspect, the present disclosure is directed to a method for optimizing workplace engagement for a plurality of employees performing a plurality of tasks. The method may include receiving productivity data for each of the plurality of employees relative to each of the plurality of tasks and receiving forecasted demands for each of the plurality of tasks. The method may also include assigning one or more of the plurality of employees to one or more of the plurality of tasks. The employee task assignments may be based upon productivity data, availability data, and the forecasted demands. The method may further include determining that the forecasted demand for one of the plurality of tasks for the period of time falls below a predetermined threshold, and assigning an inexperienced employee to that one of the plurality of tasks.

In another aspect, the present disclosure is directed to a computer readable medium having programming instructions for optimizing workplace engagement for a plurality of employees performing a plurality of tasks. The programming instructions may include receiving productivity data for each of the plurality of employees relative to each of the plurality of tasks and receiving forecasted demands for each of the plurality of tasks. The programming instructions may also include assigning one or more of the plurality of employees to one or more of the plurality of tasks. The employee task assignments may be based upon productivity data, availability data, and the forecasted demands. The programming instructions may further include determining that the forecasted demand for one of the plurality of tasks for the period of time falls below a predetermined threshold, and assigning an inexperienced employee to that one of the plurality of tasks.

In yet another aspect, the present disclosure is directed to a system for optimizing workplace engagement for a plurality of employees performing a plurality of tasks associated with logistical processes of a supply chain network. The system may include a computer configured to receive productivity data for each of the plurality of employees relative to each of the plurality of tasks and forecasted demands for each of the plurality of tasks. Receiving productivity data may include accumulating productivity data by measuring a productivity of an employee at performing a task with a tool utilized by the employee to perform the task, and receiving forecasted demands may include forecasting demands by considering information relating to at least one of shipments, production quantities, and customer demands. The system may also include a database configured to store data relating to one of employee productivity, forecasted demands, and employee availability. The system may further include a program configured to perform a first algorithm for assigning one or more of the plurality of employees to one or more of the plurality of tasks. The employee task assignments may be based upon productivity data, availability data, and the forecasted demands.

### BRIEF DESCRIPTION OF THE DRAWINGS

FIG. 1 is an illustration of an example of an organization's facility where tasks may be performed by employees of a workforce, in accordance with the present disclosure.

FIG. 2 is an illustration of an example of a spreadsheet containing employee productivity data.

FIG. 3 is a flowchart of an example of a method for allocating workforce resources in a manner that facilitates optimizing workforce engagement, in accordance with the present disclosure.

FIG. 4 is a schematic illustration of an example of a work environment for performing the method of FIG. 3.

FIG. 5 is an illustration of an example of a resource allocation schedule, in accordance with the principles of the present disclosure.

### DETAILED DESCRIPTION

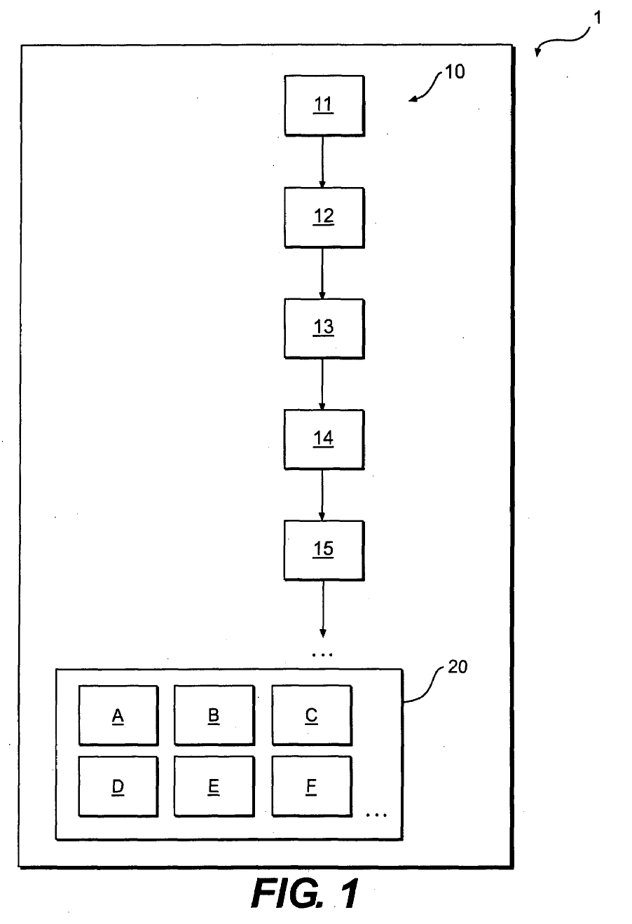

Referring now to FIG. 1, there is an illustrated example of an organization's facility 1 where tasks 11-15 may be performed by employees A-F of workforce 20, in accordance with the present disclosure. Those having ordinary skill in the art will readily recognize that the principles of the present disclosure may be applied to any organization that relies upon the services of one or more employees. Additionally, those having ordinary skill in the art will appreciate that the term “employee” may include, but is not limited to, individuals that may or may not be compensated for their services. For example, such individuals may include volunteers and salaried, hourly, or contract employees. Furthermore, although FIG. 1 illustrates that tasks 11-15 may be performed at an organization's facility 1, those of ordinary skill will recognize that tasks 11-15 may be performed, in any combination or order, at a plurality of facilities, or away from an organization's facility altogether. Still further, although FIG. 1 depicts that each of five tasks 11-15 may be performed by any one of six employees A-F, those of ordinary skill will readily recognize that a greater or lesser number of employees may perform a greater or lesser number of tasks.

With continuing reference to FIG. 1, tasks 11-15 may be any known tasks associated with an organization. For example, tasks 11-15 may be tasks associated with a parts distribution organization and may include tasks, such as, for example, unloading, inspecting, sorting, putting away, auditing, picking, packing, loading, and/or shipping. Alternatively, tasks 11-15 may be associated with a manufacturing organization and may include tasks, such as, for example, molding, sawing, welding, and/or painting. As yet another alternative, tasks 11-15 may be associated with a farming organization and may include tasks, such as, for example, planting, fertilizing, picking, washing, and/or packaging. That is to say, one having ordinary skill in the art will readily recognize that the principles of the present disclosure may be utilized by any organization having tasks that are performed by employees in a workforce. For purposes of discussion only, however, task 11 may be unloading, task 12 may be inspecting, task 13 may be sorting, task 14 may be putting away, and task 15 may be auditing.

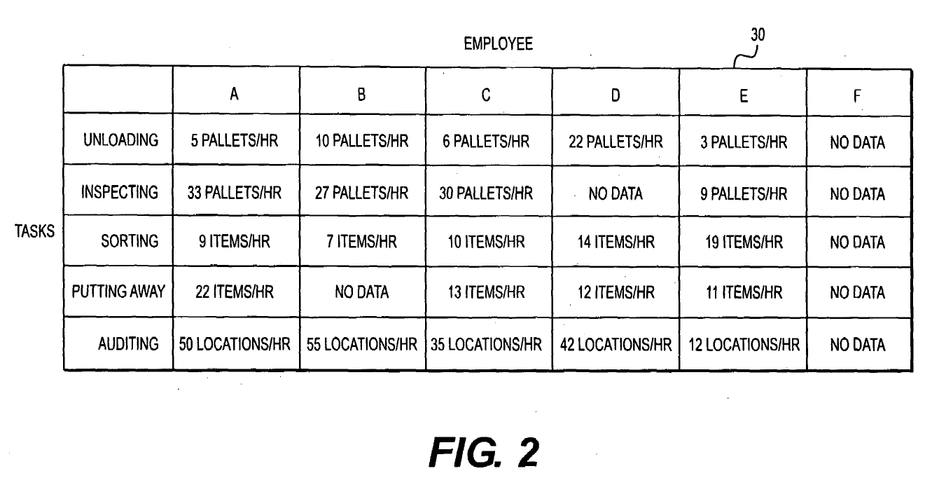

Turning to FIG. 2, there is an illustrated example of a spreadsheet 30 containing employee productivity data. Although the spreadsheet depicted in FIG. 2 contains productivity data for six employees A-F relative to five tasks, those having ordinary skill in the art will readily recognize that the productivity of a greater or lesser number of employees relative to a greater or lesser number of tasks may be contained in spreadsheet 30. Furthermore, those having ordinary skill in the art will recognize that, in addition to spreadsheet 30, any suitable manner for evaluating, considering, communicating, and/or displaying employee productivity data may be utilized. For example, employee productivity data may be also evaluated, considered, communicated, and/or displayed with the aid of, for example, a pie-chart (not shown). Employee productivity data may include, but is not limited to, historical productivity data, projected productivity data, and/or any other suitable data known in the art to represent an employee's productivity. Furthermore, employee productivity data may be represented in any suitable manner. For example, the productivity of an employee at a pallet unloading task may be represented by a numerical value, such as, for example, the number of pallets unloaded by that employee within a set time period, such as, for example, an hour. Similarly, the productivity of an employee at a location auditing task also may be represented by a numerical value, such as, for example, the number of locations audited by that employee within a set time period. Those having ordinary skill in the art will readily recognize that any suitable measurement or metric may be used to represent or quantify an employee's productivity.

Employee productivity data may be collected, maintained, displayed, and/or stored in any suitable, known format. For example, historical productivity data may be collected as an employee performs a certain task. Collection of an employee's historical productivity data may be accomplished by, for example, tracking or measuring that employee's performance as he/she performs one or more tasks. Tracking or measuring an employee's performance may be accomplished by any suitable manner known in the art. For example, an employee's performance may be tracked or measured manually, automatically, or by any combination of these two modes.

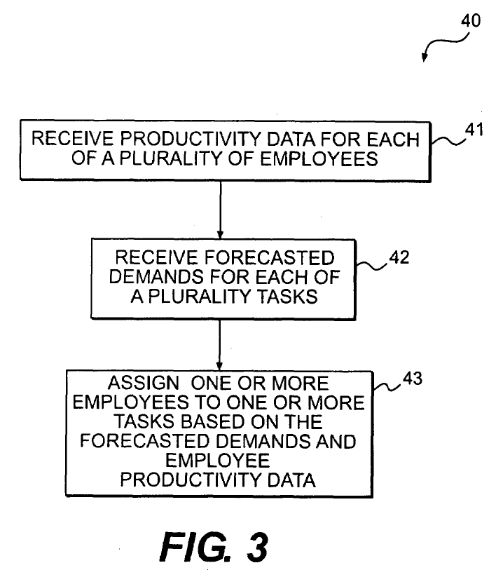

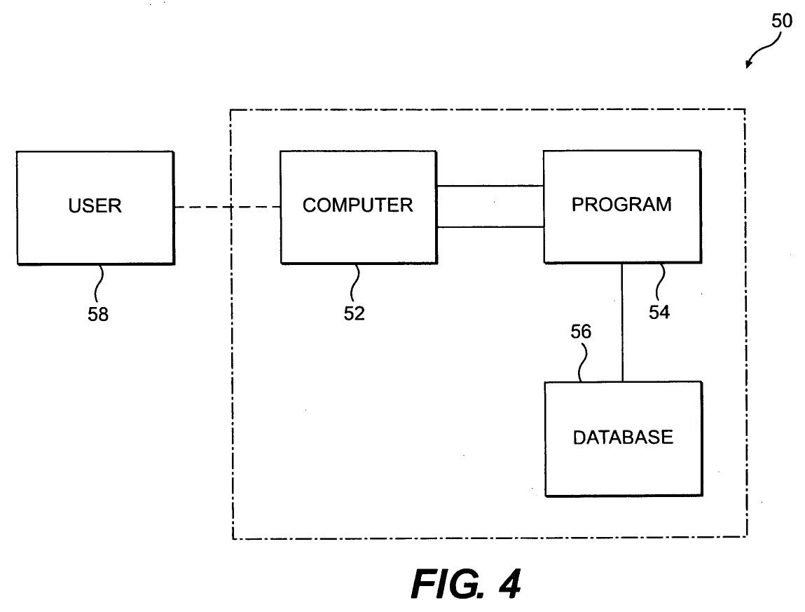

In accordance with an embodiment of the present disclosure, FIG. 3 illustrates an example of a method 40, which may be performed by a system user, such as, for example, user 58 depicted in FIG. 4, to allocate an organization's workforce resources (e.g., employees) among a plurality of tasks. In particular, method 40 may provide for developing combinations of recommended employee assignments that accommodate various demands upon an organization's workforce resources, while facilitating optimization of employee engagement. It is contemplated that employee engagement may be optimized by rotating each of the employees through each of the various tasks, while also providing time for personal reasons and/or professional development.

As shown in FIG. 3, method 40 may include a plurality of steps 41-43. Specifically, method 40 may include receiving productivity data for each of a plurality of employees, step 41. Method 40 may also include receiving forecasted demands for each of a plurality of tasks, step 42. Method 40 may further include assigning one or more employees to one or more tasks based on the forecasted demands and employee productivity data, step 43.

It is contemplated that method 40 may be performed continuously, periodically, singularly, as a batch method, and/or may be repeated as desired. Specifically, it is contemplated that method 40 may be utilized to assist in allocating available workforce resources by developing combinations of recommended employee assignments based on anticipated organizational demands and employee productivity. It is also contemplated that one or more steps associated with method 40 may be selectively omitted, that the steps associated with method 40 may be performed in any order, and that the steps associated with method 40 are described in a particular sequence for example purposes only.

With continuing reference to FIG. 3, step 41 may include, for example, receiving employee productivity data for each of a plurality of employees. Those having ordinary skill in the art will readily recognize that the productivity data for each of the plurality of employees may be relative to a plurality of tasks. In addition, employee productivity data may include employee availability data. As alluded to above, employee productivity data may be received in any suitable manner known in the art. For example, productivity data for employees may be inputted or downloaded from a storage site, such as, for example, a database. It is contemplated that receiving employee productivity data may also include accumulating such data. For example, employee productivity data may be accumulated by tracking and/or measuring an employee's productivity while that employee is performing an assigned task. Those having ordinary skill in the art will readily appreciate that any suitable manner of tracking and/or measuring an employee's productivity may be utilized with the principles of this disclosure. For example, employees may be tracked with the aid of scannable bar codes or radio frequency identification (RFID) tags. Furthermore, it is contemplated that an employee's productivity may be automatically tracked by the tools, such as, for example, hand-held barcode scanners or other electronic devices, that the employee uses to complete assigned tasks. For example, a hand-held scanner used by an employee to scan items into an inventory may be equipped with a mechanism to identify the employee using the scanner, and to record the number of items scanned into inventory by that employee. Still further, it is contemplated that in at least some embodiments of the present disclosure, employee productivity may be tracked manually. Even further, while employee productivity data may be preferably accumulated substantially prior to developing combinations of recommended employee assignments, those having ordinary skill in the art will readily appreciate that employee productivity data may not only be accumulated immediately prior to developing such combinations, but may also continue as employees are performing assigned tasks. Those having ordinary skill in the art will also readily recognize that productivity data may not be available for one or more employees, such as, for example, new or inexperienced employees.

Next, step 42 may include, for example, receiving forecasted demands for each of a plurality of tasks. Like employee productivity data, receiving forecasted demands may include inputting or downloading the forecasted demands. Furthermore, it is contemplated that receiving forecasted demands may include forecasting the demands upon an organization. Forecasting of demands may be accomplished by any suitable manner known in the art. Specifically, it is contemplated that demands may be forecasted with the aid of information relating to incoming or outgoing shipments, production quantities, customer orders, projected goals, historical data, predictive data, and/or user inputs.

Once an organization's demands have been forecasted, step 43 of method 40 may include assigning one or more employees to one or more tasks based on the forecasted demands and employee productivity data. In particular, step 43 may include processing the forecasted demands and employee productivity data to facilitate developing combinations of recommended employee assignments that accommodate the organization's demands. As discussed below in greater detail, the principles of the present disclosure particularly provide for developing combinations of recommended employee assignments that assign employees to specific tasks based on forecasted demands and employee productivity data.

Referring now to FIG. 4, there is illustrated an example of a work environment 50 for performing method 40. Work environment 50 may include a computer 52, a program 54, and a database 56. Work environment 50 may be configured to accept inputs from a user 58 via computer 52 to perform one or more steps 41-43 of method 40. Work environment 50 may be further configured to communicate and/or display data or graphics to user 58 via computer 52. It is contemplated that work environment 50 may include additional components such as, for example, a communications interface (not shown), a memory (not shown), and/or any other suitable components known in the art.

For the purposes of this disclosure, it is contemplated that a user 58 may be any person or business unit associated with an organization. Accordingly, a user 58 may be, for example, any person falling anywhere in a corporate hierarchy from top management down to a floor worker.

Computer 52 may include a general purpose computer configured to operate executable computer code. Computer 52 may include one or more input devices, such as, for example, a keyboard (not shown) or a mouse (not shown), to introduce inputs from user 58 into work environment 50 and may include one or more output devices, such as, for example, a monitor (not shown) to deliver outputs from the work environment 50 to user 58. Specifically, user 58 may deliver one or more inputs, such as, for example, data relating to forecasted demands, into work environment 50 via computer 52 to supply data associated with any of the steps of method 40 and/or to execute program 54. Computer 52 may also include one or more data manipulation devices, such as, for example, data storage or software programs (not shown), to transfer and/or alter user inputs. Computer 52 may also include one or more communication devices, such as, for example, a modem (not shown) or a network link (not shown), to communicate inputs and/or outputs with program 54. It is contemplated that computer 52 may further include additional and/or different components, such as, for example, a memory (not shown), a communications hub (not shown), a data storage (not shown), a printer (not shown), an audio-video device (not shown), removable data storage devices (not shown), and/or other components known in the art. It is also contemplated that computer 52 may communicate with program 54 via, for example, a local area network (“LAN”), a hardwired connection, and/or the Internet. It is further contemplated that work environment 50 may include any number of computers and that each computer associated with work environment 50 may be accessible by any number of users for inputting data into work environment 50, communicating data with program 54, and/or receiving outputs from work environment 50.

Program 54 may include a computer executable code routine provided on a computer readable medium containing programming instructions configured to perform one or more sub-routines and/or algorithms associated with any of steps 41-43 of method 40. Specifically, program 54, in conjunction with user 58, may be configured to perform one or more steps of method 40. Program 54 may receive inputs, such as, for example, employee productivity data and/or forecasted demands, from computer 52 and perform one or more algorithms to manipulate the received data. Program 54 may also deliver one or more outputs, such as, for example, algorithmic results, which may include recommended scheduling of workforce resources, and/or communicate via, for example, an electronic communication, the outputs to a user via computer 52. Program 54 may also access database 56 to locate and manipulate data stored therein to arrange and/or display stored productivity data to user 58 via computer 52 via, for example, an interactive object oriented computer screen display and/or a graphical user interface. It is contemplated that program 54 may be stored within the memory (not shown) of computer 52 and/or stored on a remote server (not shown) accessible by computer 52. It is also contemplated that program 54 may include additional sub-routines and/or algorithms to perform various other operations with respect to mathematically representing data, generating or importing additional data into program 54, and/or performing other computer executable operations. It is further contemplated that program 54 may include any type of computer executable code, such as, for example, C++, and/or may be configured to operate on any type of computer software.

Database 56 may be configured to store and arrange data and to interact with program 54. Specifically, database 56 may be configured to receive and store a plurality of data, such as, for example, data associated with any steps of method 40, including data relating to employee productivity and/or forecasted demands. Database 56 may store and arrange any quantity of data arranged in any suitable or desired format. In addition, database 56 may receive data through any suitable means known in the art. For example, a tool used to track and/or measure employee productivity may be configured to connect and/or download employee productivity data to database 56. Program 54 may be configured to access database 56 to identify particular data therein and display such data to a user. It is contemplated that database 56 may include any suitable type of database such as, for example, within a hierarchy or taxonomy, in groupings according to associated documents, and/or searchable according to associated identity tags. It is also contemplated that database 56 may include a single database and/or any number of databases.

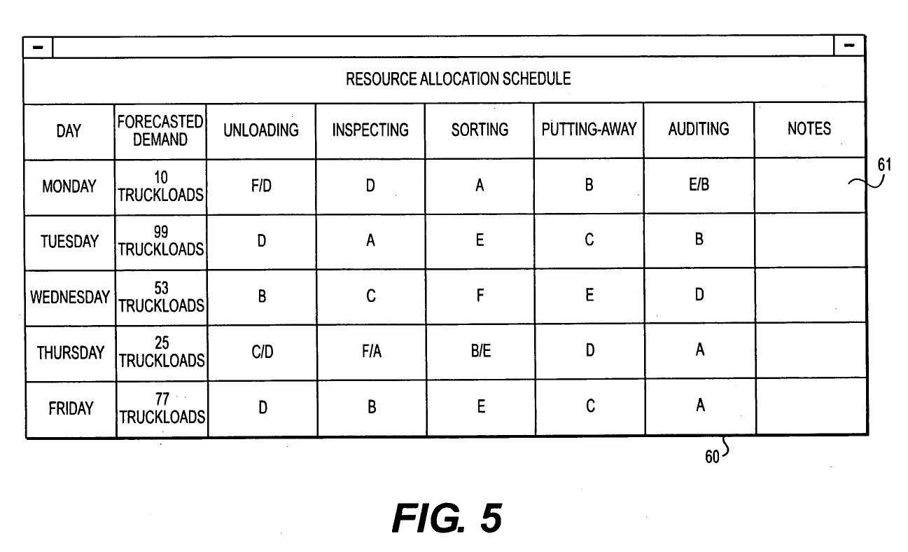

Turning now to FIG. 5, there is illustrated an example of a resource allocation schedule 60, in accordance with the principles of the present disclosure. As depicted, resource allocation schedule 60 may contain one or more recommendations, which may be based on forecasted demands and employee productivity data, for assigning combinations of employees to specific tasks, in a manner that not only meets forecasted demands, but also optimizes employee engagement. Although FIG. 6 depicts that resource allocation schedule 60 contains employee assignment recommendations for a period of five days, namely Monday through Friday, and the five tasks discussed above, those having ordinary skill in the art will readily appreciate that resource allocation schedule 60 may contain employee assignment recommendations for any period of time and for any number of tasks, not limited to the tasks noted in FIG. 5. Furthermore, it is contemplated that resource allocation schedule 60 may also include the demands forecasted with step 42 and one or more information or notes areas 61. Each information area 61 may accommodate notes entered by, for example, user 58, or notes automatically generated by a system, for example, work environment 50, utilized with the principles of the present disclosure. Such notes may include, but are not limited to, indications of employee experience, cumulative performance and productivity for an assigned combination of employees, indications of whether a particular employee is relatively more or less experienced when compared to the other employees, and any other suitable information relating to the characteristics of one or more assigned employees.

### INDUSTRIAL APPLICABILITY

As alluded to above, the method and system of the present disclosure may be generally applicable to organizations that rely upon the services of one or more employees for the performance of one or more tasks related to logistical processes of a supply chain network. Method 40 may be utilized to efficiently allocate available workforce resources by developing combinations of recommended employee assignments based on forecasted demands and employee productivity data. That is to say, the principles of the present disclosure provide for matching individual employees to specific tasks based on each employee's productivity at each of those tasks, so as to create a schedule having recommended combinations of employee assignments that accommodate various demands upon workforce resources during a given period of time. Furthermore, the principles of the present disclosure provide for optimizing employee engagement by varying an employee's task assignments. Employee task assignments may be varied in response to changes in one of employee productivity or forecasted demands. It is contemplated that varying an employee's task assignments may provide employees with an opportunity to not only enhance or develop their skills, but also remain engaged with the work they perform. In addition to increasing employee engagement and affording opportunities for growth, varying employees' task assignments may also benefit the employees' organization because each employee will become skilled at a number of tasks, which will in turn increase scheduling flexibility and reduce downtimes.

The operation of method 40 is described below with respect to the tasks and employees depicted in FIG. 1 for example purposes only, and it is understood that method 40 is applicable to any task in any supply chain network in any industry. Also for example purposes only, the principles of the present disclosure are described in connection with developing a hypothetical schedule for assigning various combinations of employees A-F to tasks 11-15 for each of days Monday through Friday in a hypothetical work week, in order to meet the daily hypothetically forecasted demands of the facility 1 for that hypothetical work week. As previously mentioned, those having ordinary skill in the art will readily appreciate that the principles of the present disclosure may be utilized in connection with allocating workforces of any size, to any number and type of tasks, for any length of time, and for any organization known in the art.

With references to FIGS. 1-5, a user 58, such as, for example, a supply chain manager for a supply chain network having a plurality of logistical processes that require the performance of tasks 11-15, may desire to determine an appropriate schedule for assigning one or more of employees A-F to one or more tasks 11-15. In determining employee assignments, user 58 may seek to create combinations of employee assignments that match employees to tasks based on a forecasted demand (e.g., a workforce resource need) for one or more of tasks 11-15, so as to match employee productivity to the forecasted demands. As mentioned above, matching employee productivity to forecasted demands may have numerous benefits, such as, for example, the ability to rotate employees among tasks as forecasted demands and/or employee productivity change. Such rotation of employees among various tasks may optimize engagement by varying the work an employee performs and/or exposing the employee to new challenges.

For example, user 58 may utilize steps 41-43 of method 40 to selectively determine various recommended assignments, which match one or more of employees A-F to one or more of tasks 11-15, for each day in the illustrated, hypothetical work week. In particular, it is contemplated that user 58 may instruct and/or operate work environment 50 to first receive productivity data for each of employees A-F (step 41). For example, productivity data for each of employees A-F may be received via user inputs or may be downloaded from a database that accumulates employee productivity data. Regardless of productivity data may be received, however, such data may first be accumulated or gathered.

For example, employee productivity data for employees A-F may be accumulated with the aid of the tools, such as, for example, hand-held scanners, that employees A-F utilize when performing assigned tasks. That is to say, the productivity of employee A at, for example, unloading pallets from a truck may be accumulated by tracking the number of pallets unloaded, and consequently scanned, by employee A during a given time period, such as, for example, one hour. For the purposes of this disclosure, it is assumed that the productivity of employee A at unloading pallets from a truck has been determined to be five pallets per hour, as shown in FIG. 2. The remaining productivities for each of employees A-F relative to each of the tasks illustrated in FIG. 2 may be similarly accumulated. As discussed above, in instances where an employee has no experience in performing a specific task, or is a new employee, productivity data may be unavailable for that employee.

Once work environment 50 has received productivity data for each of employees A-F, user 58 may instruct and/or operate work environment 50 to receive forecasted demands for each of the tasks illustrated in the first column of FIG. 2 (step 42). Like employee productivity data, forecasted demands may be received via user inputs or may be downloaded from a database that stores and/or forecasts demands for each of the illustrated tasks. However, regardless of how such demands may be received, they must be first forecasted.

For example, demands for each of the illustrated tasks may be forecasted from data available to user 58 as result of capabilities that may allow for tracking incoming and/or outgoing shipments. Specifically, it is contemplated that such data may include, but is not limited to, data relating to the performance of select logistical processes and/or supply chain networks that may be involved in receiving and/or sending shipments to and from, for example, facility 1. As a result of having access to such process and/or supply chain performance data, user 58 may be capable of evaluating the performance of the relevant logistical processes and supply chain networks to determine the volume of shipments facility 1 may be processing (e.g., sending and/or receiving) during a selected period of time. Consequently, user 58 then may be able to forecast the demands or workforce resource needs for each of tasks 11-15, which for the purposes of this example are assumed to be unloading, inspecting, sorting, putting-away, and auditing, respectively.

For illustrative purposes only, it is assumed that user 58 may forecast the demands for each of unloading, inspecting, sorting, putting away, and auditing, in a given work week, in the following manner. As shown in FIG. 5, it is assumed that user 58 may forecast workforce demands for Monday based on the arrival of 10 truckloads, the demands for Tuesday based on the arrival of ninety-nine truckloads, the demands for Wednesday based on the arrival of fifty-three truckloads, the demands for Thursday based on the arrival of twenty-five truckloads, and the demands for Friday based on the arrival of seventy-seven truckloads. For discussion purposes only, it is assumed that each truckload in the described example contains ten pallets.

Next, user 58 may operate and/or instruct work environment 50 to suggest one or more combinations of employee assignments that match one or more of employees A-F to one or more of tasks 11-15 based on the employee productivity data received in step 41 and the forecasted demands received in step 42 (step 43). As shown in FIG. 5, the suggested combinations of employee assignments may be presented to user 58 in a resource allocation schedule 60. Resource allocation schedule may display and/or present to user 58, among other things, the time period for which the suggested employee assignments may be made (e.g., a day or shift during a work week), the forecasted demands for that time period, the suggested employee assignments, and one or more notes 61, which will be discussed in detail below.

In keeping with the above mentioned example, it is assumed that work environment 50 may suggest the following combinations of employee assignments for each of days Monday-Friday. For Monday, for example, a day with a relatively low forecasted demand of ten truckloads, one hundred pallets, work environment 50 may suggest assigning employee F to unloading task 11, since employee F is inexperienced in unloading pallets from a truck. As will be readily apparent to those having ordinary skill in the art, the terms “low” and “high” as associated with forecasted demands may be determined by comparing actual forecasted demands to predetermined thresholds of demands. For example, forecasted demands that fall below the predetermined threshold may be termed “low” demands, and those forecasted demands that fall above the predetermined threshold may be termed “high” demands. In addition, given the relatively low demands expected on Monday in this discussion example, work environment may suggest assigning employee D, an employee with considerable experience and/or efficiency at unloading pallets from a truck, to supervise, train, and/or assist employee A in his/her assigned task. For the purposes of this disclosure, experienced employees include, but are not limited to, employees that have some familiarity with a particular task. Work environment 50 may also suggest assigning employees D and B to inspecting task 12 and putting away task 14, respectively, since these employees too do not have any experience in performing those tasks. Again, since employee E may be relatively inefficient and/or inexperienced at the auditing task, work environment 50 may suggest assigning employee B to supervise, train, and/or assist employee E in his/her auditing task. Next, employees A and E may be assigned to sorting task 13 and auditing task 15, respectively, since employees A and E, while somewhat experienced in these tasks, are, when compared to the other employees in workforce 20, relatively inefficient at performing tasks 13 and 15, respectively.

The principles of the present disclosure provided for taking advantages of periods of low forecasted demands to make employee assignments which promote employee training and/or education. That is to say, when demands are low, the principles of the present disclosure provide for assigning employees to tasks that they may be inefficient or inexperienced at performing.

On Tuesday, however, any training undertaken on Monday, for example, may be abandoned, since Tuesday may be a day with a relatively high forecasted demand of ninety-nine truckloads, nine hundred and ninety pallets. As such, work environment 50 may suggest assigning employees to tasks that they are most efficient at performing, in order to meet the high demands expected. Accordingly, work environment 50 may suggest assigning employee D to unloading task 11, employee A to inspecting task 12, employee E to sorting task 13, employee C to putting away task 14, and employee B to auditing task 15, since this combination of assignments matches employees to tasks that they may be relatively most efficient at performing.

On Wednesday, Thursday, and Friday, for example, days for which forecasted demands are neither extremely high nor low, work environment 50 may suggest assigning combinations of employees whose productivities ensure that the forecasted demands will be met, but may also provide for some training opportunities and/or adding variety to the employees' work routine. It is contemplated that such combinations may include assigning some employees to tasks that they may be relatively efficient at performing, while assigning other employees to tasks that they may be relatively inefficient at performing. In addition, it is contemplated that such combinations may include assigning all employees to tasks that they are neither particularly efficient nor inefficient at performing.

Furthermore, it is contemplated that the principles of the present disclosure provide for monitoring an employee's task assignments. In particular, work environment 50 may be configured to keep track of the amount of time a particular employee spends performing a specific task. Those having ordinary skill in the art will appreciate that any suitable known method of tracking the time an employee spends performing a task may be used with the principles of this disclosure. In addition, the principles of the present disclosure provide for comparing the amount of time an employee has spent performing a particular task against a predetermined threshold to determine future assignments for that employee. In instances where the time an employee has spent performing a particular task has exceeded the predetermined threshold, work environment 50 may be configured to refrain from assigning that employee to that particular task, unless an exceedingly high demand for that task is expected. It is contemplated that attempts to prevent an employee from performing a task repeatedly and over long periods of time will serve to prevent boredom and boost employee engagement.

Assigning employees in accordance with the principles of the present disclosure, as illustrated in the above discussion example, may provide various benefits. For example, in addition to providing employees with training and/or supervision opportunities during periods of low demands, the principles of the present disclosure provide for varying an employee's job function by rotating employees among various tasks as demands and/or employee productivity changes. Varying an employee's tasks in such a manner may provide for optimizing that employee's workforce engagement. Furthermore, rotating employees through various tasks and job functions may provide for training employees in a plurality of differing tasks, which in turn may make scheduling easier and reduce downtimes due to employee absences due to illness or vacations. The benefits of exposing an employee to a number of differing tasks may also include, but is not limited to, increasing employee usefulness to the employee's organization.

As discussed above, the principles of the present disclosure provide for making employee assignments based on employee productivity data and forecasted demands. Those of ordinary skill will readily recognize that it is contemplated that employee assignments may be re-determined as demands, employee productivity, and/or employee availability changes.

As discussed above, notes 61 may be included on resource allocation schedule 60. Although FIG. 5 shows notes 61 being provided for each of days Monday through Friday, those of ordinary skill in the art will recognize that a greater or lesser number of notes 61 may be provided. It is contemplated that notes 61 may include information relating to any number of characteristics for the suggested combinations of employee assignments. For example, for Monday, notes 61 may include, but is not limited to, information relating to the training, inefficiencies, and/or efficiency of one or more of the assigned employees. In particular, notes 61 may inform user 58 that employees D and B are assigned to unloading and auditing, respectively, for training purposes only. For Tuesday, for example, notes area 61 may include information relating to the efficiencies of the assigned employees. Such information may be utilized to identify which employees require further training and/or identify those employees whose productivities exceeds their contemporaries, in order to analyze that employee's method of performing an assigned task to determine performance improvement opportunities for other employees.

It will be apparent to those skilled in the art that various modifications and variations can be made to the systems and methods of the present disclosure without departing from the scope of the disclosure. In addition, other embodiments will be apparent to those skilled in the art from the consideration of the specification and practice of the systems and methods disclosed herein. It is intended that the specification and examples be considered as exemplary only, with a true scope of the disclosure being indicated by the following claims and their equivalents.

What is claimed is:

1. A method for optimizing workplace engagement for a plurality of employees performing a plurality of tasks, the method comprising:
receiving productivity data for each of the plurality of employees relative to each of the plurality of tasks;
receiving forecasted demands for each of the plurality of tasks;
assigning one or more of the plurality of employees to one or more of the plurality of tasks, the employee task assignments being based upon productivity data, availability data, and the forecasted demands; and
determining that the forecasted demand for one of the plurality of tasks for the period of time falls below a predetermined threshold, and assigning an inexperienced employee to that one of the plurality of tasks.

2. The method of claim 1, wherein receiving productivity data for each of the plurality of employees includes accumulating productivity data for each of the plurality of employees relative to each of the plurality of tasks.

3. The method of claim 2, wherein accumulating productivity data includes measuring a productivity of an employee at performing a task with a tool utilized by the employee to perform the task.

4. The method of claim 3, wherein the tool includes a barcode scanner.

5. The method of claim 1, wherein receiving forecasted demands includes forecasting demands by considering information relating to at least one of shipments, production quantities, and customer demands.

6. The method of claim 1, wherein the method further includes selecting an employee that has experience in one of the plurality of tasks to assist the inexperienced employee with that one of the plurality of tasks.

7. The method of claim 1, wherein the productivity data includes historical data for each employee relating to each of the plurality of tasks.

8. The method of claim 1, wherein the plurality of tasks includes at least one of unloading, inspecting, sorting, putting away, auditing, picking, packing, loading, and shipping.

9. A computer readable medium having programming instructions for optimizing workplace engagement for a plurality of employees performing a plurality of tasks, the programming instructions comprising:
receiving productivity data for each of the plurality of employees relative to each of the plurality of tasks;
receiving forecasted demands for each of the plurality of tasks;
assigning one or more of the plurality of employees to one or more of the plurality of tasks, the employee task assignments being based upon productivity data, availability data, and the forecasted demands; and
determining that the forecasted demand for one of the plurality of tasks for the period of time falls below a predetermined threshold, and assigning an inexperienced employee to that one of the plurality of tasks.

10. The medium with the programming instructions of claim 9, further including displaying the employee task assignments as a schedule.

11. The medium with the programming instructions of claim 9, wherein the plurality of tasks includes at least one of unloading, inspecting, sorting, putting away, auditing, picking, packing, loading, and shipping.

12. The medium with the programming instructions of claim 9, wherein receiving productivity data for each of the plurality of employees includes accumulating productivity data for each of the plurality of employees relative to each of the plurality of tasks.

13. The medium with the programming instructions of claim 12, wherein accumulating productivity data includes measuring a productivity of an employee at performing a task with a tool utilized by the employee to perform the task.

14. The medium with the programming instructions of claim 13, wherein the tool includes a hand-held barcode scanner.

15. The medium with the programming instructions of claim 9, wherein receiving forecasted demands for each of the plurality of tasks includes receiving a first forecasted demand and a second forecasted demand different from the forecasted demand.

16. The medium with the programming instructions of claim 15, wherein assigning one or more of the plurality of employees to one or more of the plurality of tasks includes creating a first combination of employee task assignments to match a cumulative productivity of the assigned employees to the first demand and a second combination of employee task assignments to match a cumulative productivity of the assigned employees to the second demand.

17. The medium with the programming instructions of claim 9, wherein receiving forecasted demands includes forecasting demands by considering information relating to at least one of shipments, production quantities, and customer demands.

18. The medium with the programming instructions of claim 9, further including selecting an employee that has experience in one of the plurality of tasks to assist the inexperienced employee with that one of the plurality of tasks.

19. The medium with the programming instructions of claim 9, wherein the productivity data includes historical data for each employee relating to each of the plurality of tasks.

20. A system for optimizing workplace engagement for a plurality of employees performing a plurality of tasks associated with logistical processes of a supply chain network, the system comprising:
a computer configured to receive productivity data for each of the plurality of employees relative to each of the plurality of tasks and forecasted demands for each of the plurality of tasks, wherein receiving productivity data includes accumulating productivity data by measuring a productivity of an employee at performing a task with a tool utilized by the employee to perform the task, and receiving forecasted demands includes forecasting demands by considering information relating to at least one of shipments, production quantities, and customer demands;
a database configured to store data relating to one of employee productivity, forecasted demands, and employee availability;
a program configured to perform a first algorithm for assigning one or more of the plurality of employees to one or more of the plurality of tasks, the employee task assignments being based upon productivity data, availability data, and the forecasted demands.
